(19) United States
(12) Patent Application Publication
(10) Pub. No.: US 2010/0238760 A1
(43) Pub. Date: Sep. 23, 2010

(54) CONSTANT LOAD SHEAR CELL FOR MAGNETORHEOLOGICAL FLUIDS

(75) Inventors: Martin Laun, Mannheim (DE); Jürgen Pfister, Speyer (DE); Rene Lochtman, Mannheim (DE); Günter Oetter, Frankenthal (DE); Claus Gabriel, Griesheim (DE); Peter Schuler, Ludwigshafen (DE)

Correspondence Address: CONNOLLY BOVE LODGE & HUTZ, LLP, P O BOX 2207, WILMINGTON, DE, 19899, US

(73) Assignee: BASF SE Patents, Trademark and Licenses, Ludwigshafen (DE)

(21) Appl. No.: 12/377,931

(22) PCT Filed: Aug. 21, 2007
(86) PCT No.: PCT/EP07/58647

§ 371 Date: Feb. 18, 2009

(30) Foreign Application Priority Data
Aug. 23, 2006 (EP) 06119401.5

(51) Int. Cl. B01F 13/08

(52) U.S. Cl. 366/127

(57) ABSTRACT

The invention relates to a constant load shear cell and a method for constant loading of a magnetorheological fluid in a constant load shear cell. The constant load shear cell comprises a rotatable shaft (1), to which a rotor plate (2) is fixed. A first gap (5), for accommodating a magnetorheological fluid, is formed between a first side (3) of the rotor plate (2) and a first shear surface (4). A second gap (8), for accommodating the magnetorheological fluid, is formed between a second side (6) of the rotor plate (2) facing away from the first and a second shear surface (7). The constant load shear cell further comprises at least one magnet (9) for generating a magnetic field in the first and second gaps (5, 8).

The present invention relates to a continuous load shear cell for magnetorheological fluids, having a rotor plate which is fastened on a rotatable shaft, and to a method for the continuous loading of a magnetorheological fluid.

Rheology is the science which deals with flow processes, i.e. with the progressive deformation of a material under the effect of external forces. The deformation in the case of flow (viscous deformation) takes place at a finite rate. In real materials, plastic and elastic behaviors are superimposed on the viscous behavior. Various rheometers are used according to the prior art in order to measure rheological quantities. Distinction is to be made between rotation rheometers, capillary rheometers, extension rheometers and constriction rheometers.

Rotation rheometers are most widespread in the laboratory. Three different measuring systems with various geometries are generally used in this case. These different measuring systems comprise cone/plate measuring systems, plate/plate measuring systems and cylinder measuring systems.

DE 199 11 441 A1 relates to a rotation viscosimeter having a cylinder measuring system, in which a measuring cylinder rotates in a cylindrical measuring beaker filled with the sample to be studied. The forces which the sample exerts on the measuring cylinder are then measured and evaluated, the sample filling the gap between the measuring cylinder and the measuring beaker.

DE 3423873 A1, AT 404192 B, AT 409304 B, AT 409422 B and AT 500358 A1 relate to plate-plate or cone-plate measuring systems, in which a sample is sheared between two plates aligned mutually parallel, one of which rotates.

Magnetorheological fluids (abbreviation: MRF) refers in general to liquids which change their rheological properties under the effect of a magnetic field. They are usually suspensions of ferromagnetic, superparamagnetic or paramagnetic particles in a carrier liquid (often referred to as a base oil). Besides such suspensions, the term “magnetorheological fluid” in the context of the present invention also covers inter alia open-celled foams which are impregnated with such a suspension, as well as elastomers which are filled with magnetic particles (magnetorheological elastomers).

If such a suspension is exposed to a magnetic field, then its flow resistance increases. This is due to the fact that the dispersed magnetizable particles, for example iron powder, form chain-like structures parallel to the magnetic field lines because of their magnetic interaction. These structures are partially destroyed during the deformation of an MRF, but they reform. The rheological properties of a magnetorheological fluid in a magnetic field resemble the properties of a plastic body with a yield point, i.e. at least a minimum shear stress must be applied in order to make the magnetorheological fluid flow.

Magnetorheological fluids belong to the group of non-Newtonian fluids. The viscosity depends greatly on the imposed shear rate. The reversible viscosity change by imposing a magnetic field can take place within milliseconds.

The rheological behavior of a magnetorheological fluid can be described approximately by a Bingham model, the yield point of which rises with an increasing magnetic field strength. For example, shear stress values of a few tens of thousands of N/m² can be achieved with magnetic flux densities of less than one tesla. High transmissible shear stresses are required for the use of magnetorheological fluids in devices such as shock absorbers, clutches, brakes and other controllable equipment (for example haptic devices, crash absorbers, steer-by-wire guiding systems, gear- and brake-by-wire systems, seals, holding systems, prostheses, fitness equipment or bearings).

Known applications of magnetorheological fluids are described, for example in U.S. Pat. No. 5,547,049, in EP 1 016 806 B1 or in EP 1 025 373 B1.

For such applications in particular the way in which a magnetorheological fluid, as well as the materials adjacent to the magnetorheological fluid, behave under prolonged loading is of interest. For example, so-called “in-use thickening” is known for magnetorheological fluids. This involves the effect that the viscosity of a magnetorheological fluid increases when (owing to high B fields) it is exposed to high shear stresses and high shear rates over a prolonged period.

Magnetorheological fluids can also cause abrasive wear of components with which they are in contact, or over which they slide during their use.

In order to study such effects, for example, it is possible to use a continuous load shear cell in which the shear of the magnetorheological fluid takes place as in a rotation rheometer and by means of which a desired energy input can be induced into the MRF sample to be studied.

Rotation rheometers known in the prior art according to the plate-cone or plate-plate principle, with two mutually rotating measuring faces, usually contain a stand or frame on which a plate is arranged. A rotatable shaft driven by a motor carries a rotor plate as a measurement body, which can be set in rotation by the motor via the shaft.

A guide bearing for the shaft is usually formed on the stand, for which an air bearing, a magnetic bearing or another low-friction bearing arrangement is for example used. In the case of an air bearing, under axial loading of the shaft by a normal force, an air cushion counters this load similarly as a spring. Such a normal force, which is generated for example by expansion of the magnetorheological fluid during heating or other effects during the measurement, acts on the rotor plate and therefore on the shaft. In the rheometers known in the prior art, however, an upper limit is placed on the permissible normal force by the configuration of the bearing, for example the air bearing, so that the functional range of the continuous load shear cell is thereby restricted.

It is an object of the present invention to avoid the disadvantages of the prior art, and in particular to provide a continuous load shear cell for magnetorheological fluids and a method for the continuous loading of a magnetorheological fluid, with which a magnetorheological fluid can be exposed to a defined load.

This object is achieved according to the invention by a continuous load shear cell and to a method for the continuous loading of a magnetorheological fluid in a continuous load shear cell. The continuous load shear cell has a rotatable shaft on which a rotor plate is fastened. A first gap for holding a magnetorheological fluid is formed between a first side of the rotor plate and a first shear face. A second gap for holding the magnetorheological fluid is formed between a second side of the rotor plate, opposite the first side, and a second shear face. The continuous load shear cell furthermore contains at least one magnet for generating a magnetic field in the first and second gaps.

A continuous load shear cell is a device in which a sample can be exposed to defined loading (defined energy input per volume of sample) by shearing over a particular period. For example, continuous loading of a sample according to the present invention may correspond to an energy input of more than 1×10¹⁰ J/m³, preferably more than 1×10¹² J/m³.

The structure of the continuous load shear cell according to the invention is based on a rotation rheometer, which operates similarly to the plate-plate and/or the cone-plate principle. A rotor plate is fastened on a rotatable shaft and is driven by a motor, for example by a laboratory stirrer. During operation of the continuous load shear cell, the rotor plate is in contact on both sides with the magnetorheological fluid to be loaded. The fluid lies in the two gaps, which are respectively bounded by one side of the rotator plate and a stationary shear face. Preferably, the gaps are substantially designed symmetrically and/or both gaps have the same height, which is determined by the distance between the surface of the rotor plate and the respective shear face.

The continuous load shear cell according to the invention furthermore contains at least one magnet for generating a magnetic field in the first and second gaps, which contain the magnetorheological fluid. Continuous loading of the magnetorheological fluid can thereby take place in a magnetic field. in order to achieve defined continuous loading, the magnetic field generated by the at least one magnet is preferably symmetrical.

The invention furthermore relates to a method for the continuous loading of a magnetorheological fluid in a continuous load shear cell, in which a rotor plate fastened on a shaft rotates, the rotor plate being in contact by a first side with the magnetorheological fluid contained in a first gap, and being in contact by a second side opposite the first side with the magnetorheological fluid contained in a second gap. During the rotation of the rotor plate, a magnetic field is generated (at least some of the time) in the first and second gaps. The magnetorheological fluid is preferably loaded in the continuous load shear cell by the rotation of the plate for a particular period, and is subsequently taken out of the continuous load shear cell, whereupon the properties of the magnetorheological fluid are studied.

The double gap measuring arrangement of the continuous load shear cell according to the invention and of the method according to the invention has the advantage that it leads to compensation for the normal forces on the rotor plate, so that the normal forces no longer limit the range of use of the continuous load shear cell as in the case of the conventional single gap. During the continuous loading of a magnetorheological fluid in a continuous load shear cell with a gap, in the style of a rotation rheometer with a measurement gap, the magnetorheological fluid in the magnetic field expands in the longitudinal direction (parallel to the shaft of the continuous load shear cell) owing to its anisotropy. The double gap arrangement of the present invention is therefore particularly advantageous for the continuous loading of magnetorheological fluids, since normal force compensation is achieved by the magnetorheological gaps arranged on both sides of the rotor plate.

A magnetic field which is symmetrical and homogeneous is preferably generated for the continuous loading of magnetorheological fluids in the two gaps. Such a symmetrical magnetic field is preferably symmetrical with respect to the rotatable shaft of the continuous load shear cell as a symmetry axis and/or with respect to the rotor plate as a symmetry plane.

According to a preferred embodiment of the present invention the at least one magnet comprises at least one permanent magnet, in particular two high-temperature neodymium permanent magnets. Such neodymium permanent magnets typically have a flux density of up to 1.2 tesla on their surface. Using permanent magnets in the continuous load shear cell according to the invention offers the advantage that the continuous load shear cell has a robust and compact structure.

The magnet may nevertheless also be an electromagnet, in particular an electromagnet having a coil, a first magnet yoke arranged above the first gap and a second magnet yoke arranged below the second gap, the first and second magnet yokes being designed symmetrically with respect to the rotor plate and with respect to the shaft. A symmetrical structure of the yoke above and below with respect to the rotor plate in the double gap makes it possible to set up a uniform magnetic flux density in both gaps, even in the event of the variation in the gap height or the properties of the magnetorheological fluid to be loaded.

The at least one magnet in the present invention is preferably configured so that a uniform magnetic flux density is achieved over the active shear regions of the two gaps.

According to a preferred embodiment of the present invention, the rotor plate is made at least partially (preferably fully) of a magnetizable material. Preferably, at least those regions of the rotor plate which are used as shear faces for the magnetorheological fluid are made of a magnetizable material. A magnetizable rotor plate (for example made of the steel type 1.0037) on a shaft made of a non-magnetizable material significantly amplifies the magnetic flux density in the gaps and improves the homogeneity of the field over the active gaps. It is nevertheless also possible to use a rotor plate made of a non-magnetizable material for the continuous load shear cell according to the invention.

The two shear faces adjacent to the gaps are preferably formed by a first and a second plate respectively adjacent to the first or second gap, or each by a surface of a magnet (for example of a magnet yoke) which is adjacent to the first or second gap. By using plates adjacent to the gaps, its material which forms a shear face adjacent to the first or second gap, which is in contact with the magnetorheological fluid and thereby stressed during continuous loading of the magnetorheological fluid, can be studied for changes at the end of continuous loading. It is therefore possible to assess the suitability of this material for applications in contact with the magnetorheological fluid being loaded.

Preferably, in the continuous load shear cell according to the invention, at least one (optionally closable) channel for holding at least one measuring sensor, selected from the group Hall probe, pressure sensor or temperature sensor, is contained in components adjacent to the gaps.

By means of a Hall probe, the effective magnetic flux density in the gaps can be measured online. For example, the Hall probe lies in a flat channel inside a non-magnetic plate below or above one of the gaps. It is also possible to carry out the using of the Hall probe during the shearing of the magnetorheological fluid in the measurement gaps, so that the magnetization change of the fluid due to the shear can be recorded. Varying the radial position of the Hall probe in the channel (perpendicularly to the rotatable shaft) makes it possible to measure the radial flux density profile. The measurement of the flux density in the gaps by the Hall probe is preferably carried out while the continuous load shear cell is at rest, by introducing the Hall probe into a channel through a closable opening.

By means of the temperature sensor, in particular a thermocouple, the temperature of the substance to be studied in the gaps can be measured online. For example, the temperature sensor lies in a flat channel inside a thermally conductive plate below or above one of the gaps, as close as possible to the magnetorheological fluid. It is also possible to carry out the measurement using the temperature sensor during the shearing of the magnetorheological fluid in the gaps, so that temperature changes of the fluid during the shearing can be recorded, and the temperature may optionally be regulated using a temperature controller provided for this purpose.

The temperature controller should as far as possible be in direct contact with the gaps, in order to ensure a maximally constant temperature in both gaps even in the event of a high energy input (high torque/high rotation speed). According to an alternative embodiment, the temperature controller is constructed so that a large part of the shear cell, which comprises a housing with the rotor plate, the gaps, at least a part of the shaft and the at least one magnet, is immersed in a thermally regulated liquid during the shearing of the magnetorheological fluid. During immersion, the magnetorheological fluid is prevented from emerging by suitable seals and/or a suitable selection of the thermally regulated liquid.

By means of a pressure sensor the pressure during the shearing can be measured online. Thus, for example, pressure changes by variation of the temperature can be observed. As well, chemical reactions leading for example to gas formation or generally to a volume expansion and thus to a pressure change can be observed. Furthermore, for example, it is possible to determine the influence of pressure on the transmittable shear stress by specifically applying pressure by measuring pressure and torque simultaneously.

According to a preferred embodiment of the present invention, the first and the second gap are closed outward by a delimiting element. This has the advantage that the magnetorheological fluid cannot emerge radially out of the gaps because of centrifugal forces during the rotation of the rotor plate. The delimiting element may be designed in one piece or a plurality of pieces. It may be arranged directly adjacent to the rotor plate circumference (without hindering the rotation) or at a particular distance from the rotor plate circumference, so that the magnetorheological fluid is in contact along the rotor plate circumference in both gaps. The delimiting element may, for example, be an annular sleeve which concentrically encloses a circular rotor plate. Since the volume of the magnetorheological fluid in the gaps may change, the delimiting element preferably comprises a subregion of an elastically compressible material. A volume expansion of the magnetorheological fluid in the event of a temperature rise is thereby absorbed by the elastically compressible material (preferably an elastically compressible foam, for example of silicone). However, if pressure changes, e.g. due to a chemical reaction, shall be measured, the delimiting element is preferably made entirely from an incompressible material. During the shearing, the magnetorheological fluid to be loaded therefore advantageously lies in a closed system (bounded by the delimiting element and the other delimiting faces of the two gaps and seal associated therewith).

At least one closable channel, for filling and/or emptying the first and the second gap with the magnetorheological fluid, preferably extends through a component adjacent to the gaps in the continuous load shear cell according to the invention. Such a channel may, for example, extend through a delimiting element which closes the gaps outward. The gaps could nevertheless be filled or emptied in the dismantled state of the continuous load shear cell. The volume of magnetorheological fluid which the gaps can hold in the continuous load shear cell according to the invention is preferably between 0.5 and 10 ml, particularly preferably be between 1 and 3 ml.

The rotor plate of the continuous load shear cell according to the invention is preferably designed circularly and has a radius in a range of preferably between 3 mm and 20 cm, particularly preferably between 5 mm and 25 mm. The rotor plate preferably comprises two plane, one plane and one conical or two conical plate surfaces. Two plane rotor plate surfaces together with two plane shear faces of the continuous load shear cell give a double plate-plate arrangement. In the plate-plate system, the magnetorheological fluid to be loaded is sheared in the gaps between the rotor plate surfaces and shear faces which are aligned mutually parallel. The shear rate is not however the same throughout the respective gap. Rather, it increases with the radius and reaches its maximum at the outer edge of the rotor plate.

Two conical rotor plate surfaces together with two plane shear faces of the continuous load shear cell give a double cone-plate arrangement. In the cone-plate system, a respective cone (rotor plate surface) in each case rotates over a plate (shear face). The magnetorheological fluid to be loaded lies in the gap respectively arranged between them. The circumferential speed increases outward on the cone surface. At the same time, the gap height increases because of the cone shape. The effect of this is that the shear rate in a vertical direction remains constant over the radius of the rotor plate. In the present invention, therefore, the double cone arrangement makes it possible to set a uniform shear rate in the two gaps. The radially inhomogeneous magnetic field resulting therefrom can be quantified by a simulation calculation and substantially compensated for by a corresponding yoke modification.

The height of the two gaps in the present invention preferably lies in the range of respectively between 0.1 and 2 mm, particularly preferably respectively between 0.8 and 1.2 mm. The gap height in the continuous load shear cell according to the invention can be adjusted through the selection of a particular rotor plate thickness. The rotor plate is therefore preferably replaceable in the continuous load shear cell according to the invention. With smaller gap heights, the maximal shear rate is increased. With predetermined permanent magnets, the strength of the magnetic field in the two gaps can be influenced for example by the selection of the thickness of plates arranged between the magnet and the respective gap.

According to a preferred embodiment of the present invention, the first and the second gap can be filled with the magnetorheological fluid adjacent to an outer subregion of the rotor plate, and the first and the second gap contain a displacer adjacent to an inner subregion of the rotor plate. Using the displacer, it is possible to exclude small radii with low shear rates and a low field, so that a narrow shear rate range is achieved by the limited radial range in which the MRF sample lies during the shear (typically, for example, a maximal factor of 2 for the different shear rates). Sealing disks (for example made of PTFE), or non-magnetic spacer discs (which may additionally receive O-rings for sealing) soldered onto the rotor plate, may for example be used as displacers.

The continuous load shear cell according to the invention preferably contains a measuring instrument for determining energy inputs into a magnetorheological fluid contained in the first and the second gaps received by rotation of the rotor plate. The energy input may, for example, be determined by measuring the torque (in which case the friction of the individual components of the shear cell must be taken into account) or by a dissipated heat measurement. In the present invention, at least one of the quantities selected from the group of torque exerted on the shaft, magnetic field strength of the magnet, temperature of the magnetorheological fluid, rotation speed of the rotor plate and power input into the magnetorheological fluid is preferably measured during the continuous loading. These quantities may be measured or determined directly or indirectly, continuously or at intervals. In order to determine the energy input, it is necessary to measure the torque and the rotation speed continuously.

In order to determine the rheological properties of the magnetorheological fluids being loaded, it is possible to make the shaft rotate at a constant rotation speed and measure the torque required for this. It is nevertheless also possible to apply a constant torque to the shaft using the motor, and measure the rotation speed or rotation position resulting from the torque exerted on the rotor plate. The shaft may furthermore execute a sinusoidal rotation movement or a rotation movement corresponding to another waveform (oscillation experiment), in which case the elastic component of the magnetorheological fluid can also be determined besides the viscous part. In each case, the torque which the magnetorheological fluid exerts on the rotor plate during the latter's movement is measured (optionally indirectly) by the measuring instrument.

A consistency change of the magnetorheological fluid during the shearing (in-use thickening—IUT) may, for example, be recorded by measuring the torque profile as a function of time (directly via a torque measurement shaft or indirectly via the motor current), in which case it is necessary to take into account the basic friction superimposed by the bearing and seals).

According to one embodiment of the invention, the torque profile or the profile of the rotation speed on the shaft of the shear cell is measured continuously during the rotation of the rotor plate in the shearing generated thereby. According to a further embodiment, phases alternately take place in which the rotation of the rotor plate is used exclusively to shear the magnetorheological fluid, and phases in which a measurement of the torques or rotation speeds takes place during the movement (for example rotation or oscillation) of the rotor plate for rheological characterization of the magnetorheological.

The continuous load shear cell according to the invention is preferably constructed so that it can be dismantled with few working steps, so that the MRF sample loaded in the shear cell can be removed after defined loading for the purpose of rheological characterization (change in the viscosity and characteristic of shear stress against flux density) and analysis (change in the components, CIP morphology (electron microscopy), density, CIP concentration). The CIP morphology describes the particle size and a particle size distribution of a carbonyl-iron powder being used. The rheological characterization may take place in a rheometer after removing the MRF sample.

An easily assembled and dismantled modular structure of the continuous load shear cell according to the invention furthermore allows great flexibility in respect of geometry and materials, particularly of the rotor plate and shear faces. Dismantling the rotor plates and the plates used as shear faces after defined loading of a magnetorheological fluid permits characterization of the wear and the surface modification of materials contained therein, which come in contact with the magnetorheological fluid.

According to a preferred embodiment of the present invention, the continuous load shear cell comprises a housing which has an engagement element for engaging a dismantling device when dismantling and assembling the continuous load shear cell. Such a dismantling device is advantageous particularly in a continuous load shear cell having permanent magnets since it is necessary to overcome the magnetic attraction force in order to dismantle the cell, and assembly can take place in a controlled way despite the attraction force. A threaded part on the continuous load shear cell, into the inner or outer screw thread of which an outer or inner screw thread of a part of the dismantling device can respectively engage, may for example be used as an engagement element for engaging the dismantling device.

According to an alternative embodiment of the present invention, the rotatable shaft of the continuous load shear cell according to the invention can be coupled to further continuous load shear cells connected in parallel or in series. A series circuit of cells (with a common rotatable shaft) or a parallel circuit of cells (with a common drive for the individual rotatable shafts of all the cells) allow continuous load experiments to be carried out simultaneously. For example, a plurality of magnetorheological fluids and/or a plurality of rotor plate materials may be tested simultaneously.

The invention will be explained in more detail below with the aid of the drawing, in which:

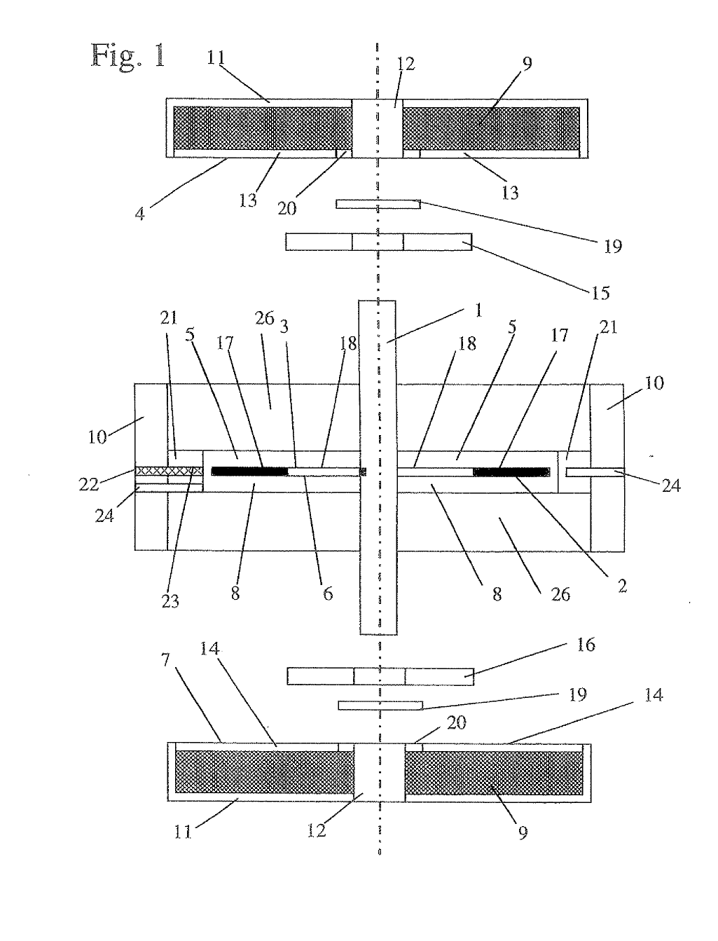

FIG. 1 shows a schematic exploded representation of a first embodiment of the continuous load shear cell according to the invention,

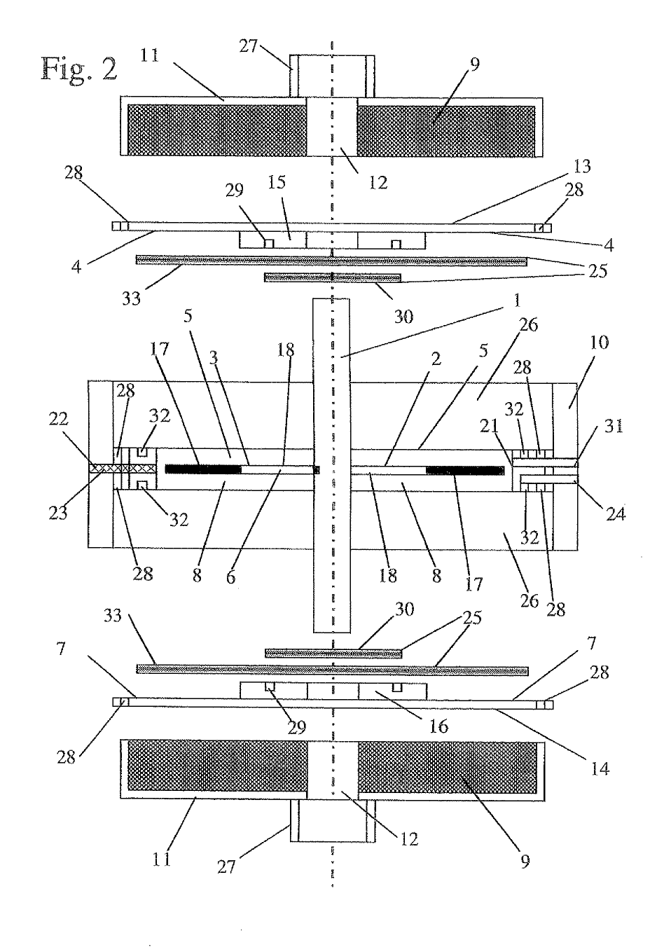

FIG. 2 shows a schematic exploded representation of a second embodiment of the continuous load shear cell according to the invention, and

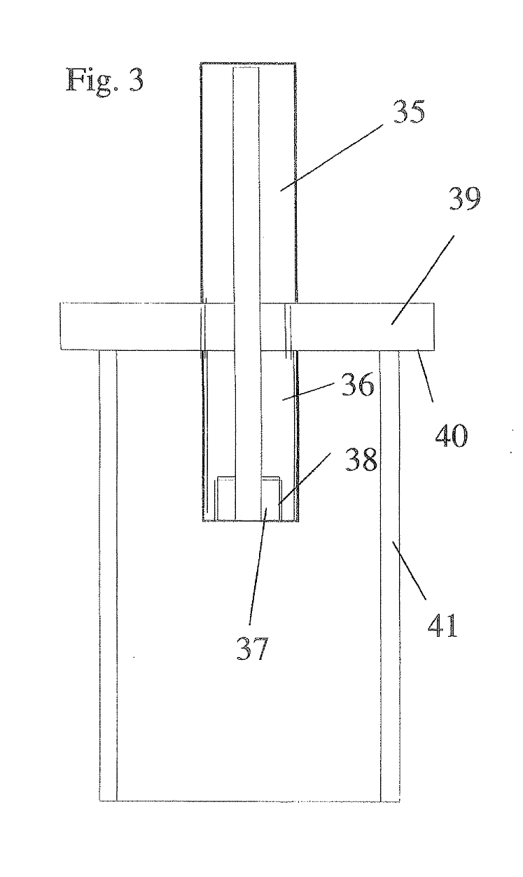

FIG. 3 shows a schematic representation of a dismantling device for a continuous load shear cell according to the invention.

The continuous load shear cell according to FIG. 1 comprises a rotor plate 2 made of a magnetizable material (for example soft iron or steel—material number 1.0037) fastened on a rotatable shaft 1 made of a non-magnetizable material (for example austenitic stainless steel—for example material number 1.4571). The rotatable shaft 1 is connected to a motor (not shown) that drives the shaft 1, which is preferably mounted using an air bearing (not shown). A first gap 5, which can hold a magnetorheological fluid, is arranged between the upper side of the rotor plate 2 (first side 3) and a first shear face 4. A second gap 8, which can likewise hold the magnetorheological fluid, is formed between the lower side of the rotor plate 2 (second side 6) and a second shear face 7.

The continuous load shear cell furthermore comprises neodymium magnets 9, which can be fitted into a housing 10 so that they flank the gaps 5, 8. The permanent magnets 9 respectively engage in a housing part 11, which contains a central bore 12 for receiving the shaft 1. When the housing parts 11 with the permanent magnets 9 are fitted into compartments 26 provided for them in the housing 10, the permanent magnets 9 generate a magnetic field in the first and second gaps 5, 8. The bore 12 contains bearings (not shown) which prevent the shaft 1 from moving sideways.

The first and the second shear face 4, 7 are formed by a first plate 13 adjacent to the first gap 5 and a second plate 14 adjacent to the second gap 8, respectively, both plates 13, 14 being removable from the associated housing part 11. The magnetic field strength in the gaps 5, 8 can be influenced by selecting the thickness of the plates 13, 14.

Before the housing parts 11 with the permanent magnets 9 contained in them are fitted into the housing 10, a first Teflon sealing disk is placed as a first displacer 15 in the first gap 5 and a second Teflon sealing disk is placed as a second displacer 16 in the second gap 8. Because of the displacers 15, 16, the gaps 5, 8 can be filled with a magnetorheological fluid only adjacent to an active outer subregion 17 (represented in black) of the rotor plate 2 and not adjacent to an inactive inner subregion 18 (represented in white) of the rotor plate 2. During operation of the continuous load shear cell, the shearing of the magnetorheological fluid therefore takes place in a narrow shear rate range only adjacent to the outer subregion 17 of the rotor plate 2.

Sealing elements 19, which are held in recesses 20 formed for them in the plates 13, 14, are furthermore provided for sealing the gaps 5, 8 from the respective central bore 12. Suitable sealing elements 19 are for example O-rings, quadrings, labyrinth seals, slide ring seals or any other sealing element for sealing rotating elements known to those skilled in the art.

Integrated into the housing 10, there is a delimiting element 21 which closes the gaps 5, 8 outward. The delimiting element 21 contains a subregion 23 in the form of a bore, which is filled with a compressible material 22 (silicone rubber). This subregion with the compressible material 22 is used to absorb a volume expansion of the magnetorheological fluid in the gaps 5, 8, which is fully enclosed in the gaps 5, 8 during operation of the continuous load shear cell.

Channels 24, which are intended to hold measuring sensors (for example Hall probes and/or temperature sensors), are formed in the housing 10 and in the delimiting element 21.

The rotor plate 2 in the embodiment represented comprises two plane plate surfaces on its two sites 3, 6. This is therefore a double plate-plate arrangement.

The method according to the invention for the continuous loading of a magnetorheological fluid can be carried out with the continuous load shear cell as represented in FIG. 1.

FIG. 2 shows a schematic exploded representation of a further continuous load shear cell according to the invention.

The continuous load shear cell comprises a rotatable shaft 1 with a rotor plate 2, a first gap 5 for holding a magnetorheological fluid being formed between the first side 3 of the rotor plate 2 and the first shear face 4 and a second gap 8 for holding a magnetorheological fluid being formed between a second side 6 of the rotor plate 2, which lies opposite the first side 3, and a second shear face 7.

The continuous load shear cell furthermore comprises permanent magnets 9, for generating magnetic field in the first and second gaps 5, 8 when the cell is assembled. While each being partially enclosed by a housing part 11, the permanent magnets 9 are installed in compartments 26 of the housing 10 after sealing elements 25 and plates 13, 14 have been accommodated there. The permanent magnets 9 with their housing parts 11 comprise a central bore 12 for receiving the shaft 1. The bore 12 contains bearings (not shown) which prevent the shaft 1 from moving sideways. On the outside, the housing parts 11 respectively comprise a pin with an outer screw thread, which is used as an engagement element 27 for engaging a dismantling device for assembling and dismantling the continuous load shear cell.

The first and second shear faces 4, 7 are respectively formed by a first plate 13 adjacent to the first gap 5 and a second plate 14 adjacent to the second gap 8. The plates 13, 14 each comprise annular projections, which are used as displacers 15 and 16 as soon as the plates 13, 14 are screwed together with the housing 10 of the shear cell (via the bores 28). The gaps 5, 8 can then be filled with the magnetorheological fluid adjacent to the outer subregion 17 of the rotor plate 2, but adjacent to the inner subregion 18 of the rotor plate 2 they cannot be filled with magnetorheological fluid owing to the presence of the displacers 15, 16. The displacers 15, 16 comprise recesses 29 to receive sealing elements 30, e.g. small O-rings, quadrings, labyrinth seals or slide ring seals.

The delimiting element 21, which closes the gaps 5, 8 outward, is formed integrally with the housing 10. The delimiting element 21 contains a subregion 23, which is filled with compressible material 22, and a channel 24 to hold measuring sensors. A filling channel 31 is used for filling the gaps 5, 8 with magnetorheological fluid and is closed during operation of the continuous load shear cell. Sealing elements 33, e.g. large O-rings, which seal the gaps 5, 8 outward, are placed in recesses 32 in the delimiting element 21.

The method according to the invention for the continuous loading of a magnetorheological fluid can be carried out with the continuous load shear cell as represented in FIG. 2.

FIG. 3 shows a dismantling device 34 for a continuous load shear cell, for example for a shear cell according to FIG. 2

The dismantling device 34 is used for dismantling and assembling continuous load shear cells according to the invention, particularly those which contain permanent magnets. The dismantling device contains a threaded rod 35 with an outer screw thread 36. The threaded rod 35 comprises an axial bore 37 with an inner screw thread 38, which can be screwed onto an engagement element of a continuous load shear cell. A knurled nut 39, on the lower side 40 of which a support tube 41 (for example made of Plexiglas) is fastened, is screwed onto the outer screw thread 36 of the threaded rod 35.

In order to disassemble a continuous load shear cell, the inner screw thread 38 of the threaded rod 35 is screwed onto an engagement element of the shear cell, so that the support tube 41 is supported on a component of the housing of the shear cell. The knurled nut 39 is then screwed upward on the threaded rod 35 until the shear cell component hanging from the engagement element (for example a housing part with permanent magnets contained in it) is removed far enough away from the rest of the shear cell. This component may then optionally be removed fully from the shear cell.

### LIST IF REFERENCES

1 rotatable shaft
2 rotor plate
3 first side
4 first shear face
5 first gap
6 second side
7 second shear face
8 second gap
9 neodymium permanent magnet
10 housing
11 housing part
12 central bore
13 first plate
14 second plate
15 first displacer
16 second displacer
17 outer subregion
18 inner subregion
19 sealing element
20 recesses
21 delimiting element
22 compressible material
23 subregion
24 channels
25 sealing element
26 compartment
27 engagement element
28 bores
29 recesses
30 sealing element
31 Filling channel

### 32 Recesses

33 sealing element
34 dismantling device
35 threaded rod
36 outer screw thread
37 axial bore
38 inner screw thread
39 knurled nut
40 lower side
41 support tube

1.-16. (canceled)

17. A continuous load shear cell for magnetorheological fluids, having a rotatable shaft (1) on which a rotor plate (2) is fastened, a first gap (5) for holding a magnetorheological fluid being formed between a first side (3) of the rotor plate (2) and a first shear face (4) and a second gap (8) for holding the magnetorheological fluid being formed between a second side (6) of the rotor plate (2), opposite the first side, and a second shear face (7), and the continuous load shear cell containing at least one magnet (9) for generating a magnetic field in the first and second gaps (5, 8), wherein the first and the second gap (5, 8) can be filled with the magnetorheological fluid adjacent to an outer subregion (17) of the rotor plate (2), and the first and the second gap (5, 8) contain a displacer (15, 16) adjacent to an inner subregion (18) of the rotor plate (2).

18. The continuous load shear cell according to claim 17, wherein the rotor plate (2) is made at least partially of a magnetizable material.

19. The continuous load shear cell according to claim 17, wherein the at least one magnet (9) comprises at least one permanent magnet.

20. The continuous load shear cell according to claim 17, wherein the first and second shear faces (4, 7) are formed by a first and a second plate (13, 14) respectively adjacent to the first or second gap (5, 8), or each by a surface of the magnet (9) which is adjacent to the first or second gap (5, 8).

21. The continuous load shear cell according to claim 17, wherein the first and the second gap (5, 8) are closed outward by a delimiting element (21).

22. The continuous load shear cell according to claim 21, wherein the delimiting element (21) comprises a subregion (23) of an elastically compressible material (22).

23. The continuous load shear cell according to claim 17, wherein a closable channel (31) for filling the first and the second gap (5, 8) with the magnetorheological fluid, extends through a component adjacent to the gaps (5, 8).

24. The continuous load shear cell according to claim 17, wherein at least one channel (24) for holding at least one measuring sensor, selected from the group Hall probe, pressure sensor or temperature sensor, is contained in a component adjacent to the gaps (5, 8).

25. The continuous load shear cell according to claim 17, wherein the rotor plate (2) comprises two plane, one plane and one conical or two conical plate surfaces.

26. The continuous load shear cell according to claim 17, containing a measuring instrument for determining energy inputs into a magnetorheological fluid contained in the first and the second gaps (5, 8) received by rotation of the rotor plate (2).

27. The continuous load shear cell according to claim 17, comprising a housing (11) which has an engagement element (27) for engaging a dismantling device (34) when dismantling and assembling the continuous load shear cell.

28. The continuous load shear cell according to claim 17, wherein the rotatable shaft (1) can be coupled to further continuous load shear cells connected in parallel or in series.

29. A method for the continuous loading of a magnetorheological fluid in a continuous load shear cell, comprising rotation of a rotor plate fastened on a shaft, the rotor plate being in contact on a first side with the magnetorheological fluid contained in a first gap, and being in contact on a second side opposite the first side with the magnetorheological fluid contained in a second gap, and generation of a magnetic field in the first and second gaps during the rotation of the rotor plate, wherein the first and the second gap contain a displacer adjacent to an inner subregion of the rotor plate.

30. The method according to claim 29, wherein at least one of the quantities selected from the group of torque exerted on the shaft, magnetic field strength of the magnetic field, temperature of the magnetorheological fluid, rotation speed of the rotor plate and power input into the magnetorheological fluid is measured during the continuous loading.

31. The method according to claim 29, wherein the magnetorheological fluid is loaded in the continuous load shear cell by rotating the rotor plate for a particular period, and is subsequently removed from the continuous load shear cell and the properties of the magnetorheological fluid are studied.

32. The method according to claim 29, wherein a material of at least one shear face adjacent to one of the first and second gaps, which is in contact with the magnetorheological fluid and thereby stressed during the continuous loading, is studied for changes at the end of continuous loading.
